(19) United States
(12) Patent Application Publication
(10) Pub. No.: US 2006/0206685 A1
(43) Pub. Date: Sep. 14, 2006

(54) Lookahead control method

(76) Inventor: Yuji Fujiki, Tokyo (JP)

Correspondence Address: RABIN & Berdo, PC, 1101 14TH STREET, NW, SUITE 500, WASHINGTON, DC, 20005, US

(21) Appl. No.: 11/262,773

(22) Filed: Nov. 1, 2005

(30) Foreign Application Priority Data
Mar. 8, 2005 (JP) 064451/2005

(51) Int. Cl. G06F 12/00

(52) U.S. Cl. 711/204

(57) ABSTRACT

The present invention provides a method for controlling lookahead of memory data with respect to one bus master selected in a system to which a plurality of bus masters and a memory are connected, comprising the step of determining whether lookahead control should be carried out, based on a signal for discriminating the selected bus master and a signal for discriminating the type of transfer.

### BACKGROUND OF THE INVENTION

The present invention relates to lookahead control of a read buffer disposed within a memory controller in a system having a plurality of masters.

A system for making a request for a high-speed data transfer might be provided with masters for voluntarily generating access requests in addition to a CPU. For the purpose of an improvement in performance, a memory controller for controlling a main memory predicts an access to be next done from an access accepted in the past to perform lookahead and fetches pre-read data into a read buffer lying in the memory controller, and then sends back data immediately through the read buffer when the predicted access arrives, thereby improving the performance of the system.

FIG. 4 is a view showing a configuration of a conventional system 40 equipped with a plurality of masters, and FIG. 5 is a view showing operating timings of the conventional system where lookahead has succeeded, respectively.

In FIG. 4, an address signal (addr) and a signal (burst) indicative of the type of transfer, which are sent from masters (CPU, master 1 and master 2), and ready corresponding to a reply signal and rdata indicative of read data sent from slaves are inputted/outputted via a system bus 41. The addr indicates an address for an access destination, and the burst indicates the type of transfer. As the type of burst, there are known a “FIXED” transfer at which the number of transfers has been determined in advance, and a “NOTFIXED” transfer at which the number of transfers has not been determined.

The CPU (42), the master 1 (43), the master 2 (44) and a memory controller 45 are respectively connected to the system bus 41. The CPU, master 1 and master 2 require an arbiter 46 to receive use requests of the system bus through the use of signals such as busreq0, busreq1 and busreq2 respectively. When the arbiter 46 accepts the requests, it issues an enabling signal for the system bus to one master. Busgrant0, busgrant1 and busgrant2 respectively correspond to enabling signals for the CPU, master 1 and master 2. The master that has accepted the enabling signal therein is able to use the system bus and outputs addr and burst signals to the system bus 41.

On the other hand, the memory controller 45 is connected to a memory 47 thereoutside and has the function of controlling between the memory and the system bus. The memory controller 45 generates an address signal (maddr) and a control signal (mct1) for the memory at a memory control unit 45a in response to an access made from the system bus and obtains access to the memory 47. Red data (mdata) from the memory is outputted onto the system bus 41 as rdata. The memory control unit 45a outputs a ready signal indicative of the completion of a response to access made from each master. Therefore, the respective masters are capable of obtaining response timings and read data corresponding to the accesses outputted from the masters themselves.

The memory controller 45 shown in FIG. 4 is provided with a read buffer 45b. When the contents indicative of an address signal (addr) sent from each master already exist within the read buffer, the memory control unit 45a sends back data sent from the read buffer to the memory as read data (rdata) without accessing the memory. At this time, the read buffer 45b can send back a read signal at a high speed as compared with the case in which read data (mdata) from the memory is obtained and a ready response is performed.

FIG. 5 is a time chart showing a specific example where lookahead is conducted for access made from each master and is made successful in the next access.

The memory controller 45 having accepted addr=A and A+1 and burst=“FIXED” (taken as two continuous accesses) outputs maddr=A and A+1 corresponding to real addresses of the external memory 47, and mct1 corresponding to a suitable control signal from the memory control unit 45a and performs a memory access to obtain mdata=D and D+1 as read data (T2-T6). The mdata=D and D+1 respond to the system bus, based on rdata and ready at timings of T5 and T7 respectively.

The memory control unit 45a executes lookahead in response to the accepted accesses to thereby obtain read data D+2 and D+3 relative to maddr=A+2 and A+3, and stores them in the read buffer 45b. Since the memory control unit 45a having accepted an access for addr=A+2 at T11 has succeeded in lookahead, it sends back D+2 through the read buffer without accessing the memory.

The above has been disclosed in Japanese Patent Laid-Open No. 2001-229074.

(1) When lookahead rules differ every masters:

The transfer of data from the masters 1 and 2 and CPU to the memory controller in the system shown in FIG. 4 will be explained in parts.

As to the transfer from the masters 1 and 2 to the memory 47, there is a case in which massed data are continuously transferred at a time in general, and there is a case in which a burst transfer (“FIXED” transfer) at which the number of transfers has been determined in advance, is used as a bus's protocol. As reasons therefor, there may be mentioned advantages that (a) it is often the case that memories respectively have fixed page sizes, and the execution of a block transfer for each page size unit provides a good efficiency, and (b) since the completion of transfer on the system bus can be predicted, a useless time at the switching of each master can be reduced.

When the masters 1 and 2 are performing the “FIXED” transfer, there is a high possibility that the masters will next carry out the “FIXED” transfer too. In the case of a read access, there is a high possibility that lookahead will succeed, and an improvement in performance can be expected. When the “FIXED” transfer is not done in reverse, there is a high possibility that data will not be in continuous transfer. When the lookahead is performed, an extra access occurs, thus resulting in an increase in power consumption. FIG. 6 shows timings at the execution of lookahead in the case of a non-“FIXED” transfer. Accesses made with timings of T8 and T10 shown in FIG. 6 lead to needless ones, thus resulting in an increase in power consumption.

On the other hand, there is a case in which a continuous transfer other than the “FIXED” transfer is done from the CPU although depending even on an instruction system. In this case, when lookahead control is performed under the same rules as other masters, no lookahead is carried out upon the continuous transfer, thus reducing an improvement in performance. In this case, the execution of such lookahead as shown in FIG. 5 rather provides expectations on an improvement in performance even at other than at the “FIXED” transfer.

In the related art, decisions as to whether the lookahead should be done or not are not carried out every masters, and compatibility between the improvement in performance and the reduction in power consumption has not been ensured.

(2) As to lookahead where addresses are not continuous:

There is a case in which when a continuous transfer from a given master to the memory controller is carried out, addresses are not contiguous. When a value incremented from the present address is used as a lookahead address in such a case, the lookahead surely fails, thus resulting in a needless increase in power consumption. Since functions differ every masters in this case, there is a need to adopt a lookahead prediction method suitable for the masters in order to enhance lookahead accuracy.

As described above, in order to ensure compatibility between the improvement in performance and the reduction in power consumption, its advantageous effect is brought about as lookahead prediction accuracy becomes high. It can be said that decisions as to whether lookahead should be carried out every masters different in operation, produce high prediction accuracy.

### SUMMARY OF THE INVENTION

With the foregoing in view, the present invention aims to make compatible an improvement in performance and a reduction in power consumption by changing lookahead control every masters different in function.

According to one aspect of the present invention, for attaining the above object, there is provided a method for controlling lookahead of memory data with respect to one bus master selected in a system to which a plurality of bus masters and a memory are connected, comprising the step of determining whether lookahead control is carried out, based on a signal for discriminating the selected bus master and a signal for discriminating the type of transfer.

According to another aspect of the present invention, for attaining the above object, there is provided a method for controlling lookahead of memory data with respect to one bus master selected in a system to which a plurality of bus masters and a memory are connected, comprising the step of when it is determined that lookahead control is performed, based on a signal for discriminating the selected bus master and a signal for discriminating the type of transfer, allowing a lookahead address for the lookahead control to be controlled based on the bus master discrimination signal.

In the one aspect of the present invention as described above in detail, a memory controller that accepts accesses from a plurality of masters controls, every masters, based on a signal for discriminating each bus master and a signal for discriminating the type of transfer, whether lookahead control should be carried out. Thus, the accuracy of lookahead can be enhanced and hence needless or unnecessary lookahead addresses are reduced, thereby making it possible to suppress an increase in power consumption.

In another aspect of the present invention as well, suitable lookahead addresses can be predicted every masters even when addresses to be accessed are non-continuous. Thus, lookahead accuracy is enhanced and an increase in power consumption is reduced. Further, an improvement in performance due to a lookahead success is also realized.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a view showing a configuration of a system according to a first embodiment, on which a method of the present invention is implemented;

FIG. 2 is a time chart for describing the operation of the system according to the first embodiment;

FIG. 3 is a view illustrating a configuration of a system according to a second embodiment, on which a method of the present invention is implemented;

FIG. 4 is a view showing the configuration of the conventional system 40 equipped with the plurality of masters;

FIG. 5 is a time chart showing a conventional specific example where lookahead is conducted for access made from a master and is made successful in the next access; and

FIG. 6 is a time chart illustrating a conventional specific example where lookahead has failed.

### DETAILED DESCRIPTION OF THE PREFERRED EMBODIMENTS

Preferred embodiments of the present invention will hereinafter be described in detail with reference to the accompanying drawings. Incidentally, the respective figures are merely approximate illustrations to enable an understanding of the present invention.

### First Preferred Embodiment

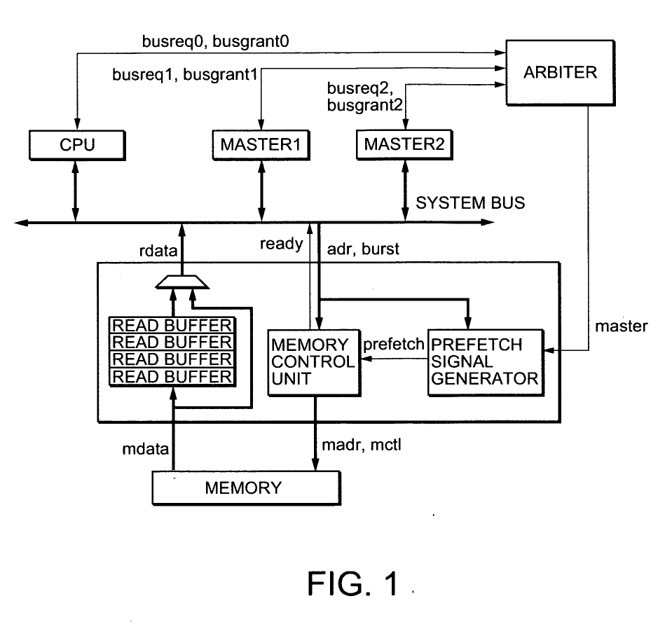

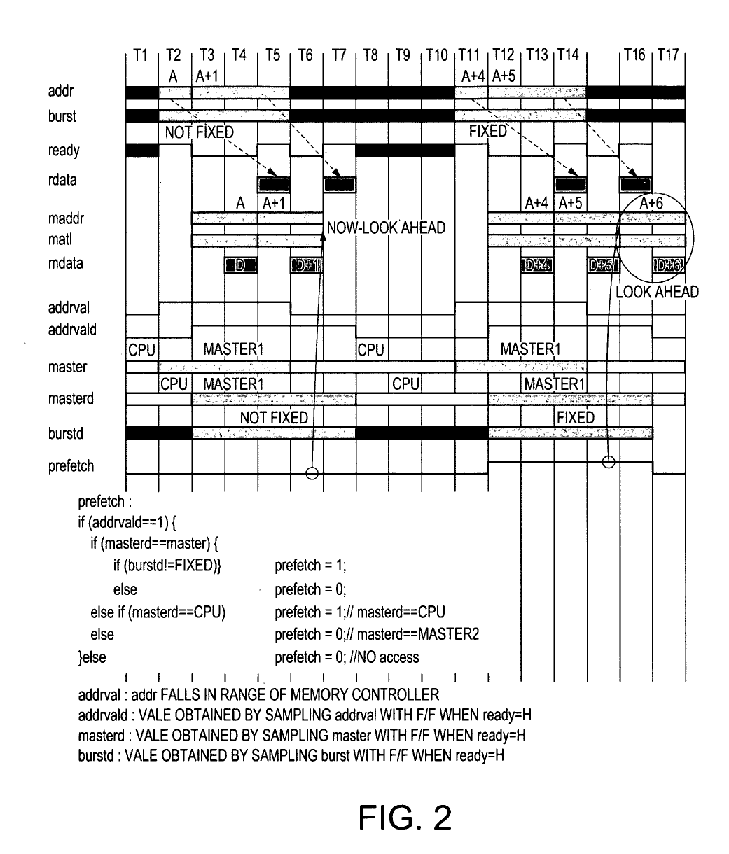

A lookahead control method according to the first embodiment is of a method for discriminating accesses made from a plurality of masters under lookahead control of a read buffer in a memory controller accessed from the plural masters to thereby enhance lookahead accuracy in accordance with the characteristics of operations done every masters. FIG. 1 is a view showing a configuration of a system 10 according to the present embodiment, and FIG. 2 is a time chart for describing the operation thereof, respectively.

In FIG. 1, respective signals such as addr and burst outputted from respective masters (CPU (12), master 1 (13) and master 2 (14)), ready indicative of a response or reply signal from each slave, rdata indicative of read data, etc. are inputted from and outputted to a system bus 11. The addr indicates each address to be accessed or for an address destination, and the burst indicates the type of transfer. As the burst, there are known a “FIXED” transfer at which the number of transfers has been determined in advance, and a “NOTFIXED” transfer at which the number of transfers has not been determined.

The CPU (12), the master 1 (13), the master 2 (14) and the memory controller 15 are respectively connected to the system bus 11. The CPU, master 1 and master 2 require an arbiter 16 to receive use requests of the system bus 11 through the use of signals such as busreq0, busreq1 and busreq2 corresponding to bus request signals respectively. When the arbiter 16 accepts them, it issues an enabling signal for the system bus 11 to one master. busgrant0, busgrant1 and busgrant2 respectively correspond to enabling signals for the CPU, master 1 and master 2.

The master that has received the enabling signal therein is able to use the system bus and outputs addr and burst to the memory controller 15. On the other hand, the memory controller 15 is connected to a memory 17 thereoutside and has the function of controlling between the memory 17 and the system bus 11. The memory controller 15 generates an address signal (maddr) and a control signal (mct1) at a memory control unit 15a in response to an access made from the system bus 11 and obtains access to the memory 17 to output read data (mdata) from the memory 17 to the system bus 11 as read data (rdata). The memory control unit 15a outputs a ready signal indicative of the completion of a response together with rdata in response to an access made from each master. Thus, the respective masters are capable of obtaining response timings and read data corresponding to the accesses outputted from the masters themselves.

The memory controller 15 shown in FIG. 1 is further provided with a read buffer 15b. When the contents indicative of an address signal (addr) made from each master already exist within the read buffer 15b, the memory control unit 15a sends back data sent from the read buffer 15b to the memory as read data (rdata) for the memory without accessing the memory 17. At this time, the read buffer 15b is capable of sending back ready at high speed as compared with a case in which mdata is obtained from the memory and a ready response is made.

The arbiter 16 outputs a signal (master) capable of determining which master is now using the present system bus 11, to the memory controller 15. This signal (master) can easily be generated from the arbiter. A “prefetch” signal generator 15c inputs signals (master, burst, ready and addr) therein and outputs a “prefetch” signal to the memory control unit 15a. The memory control unit 15a determines based on the value of the inputted “prefetch”, whether lookahead should be carried out.

FIG. 2 is a time chart showing the operation of the system according to the first embodiment. At a time T2, a signal (master) indicative of an access source being of the master 1 is outputted from the arbiter 16 to the memory controller 15. A signal (masterd) based on the outputted signal is generated. Simultaneously with it, a synchronous signal (burstd) based on the signal (burst) indicative of the transfer type sent through the system bus 11 is generated at the “prefetch” signal generator 15c. Since burstd corresponds to “NotFIXED” in this case, a lookahead signal is set to “prefetch”=0 according to logic illustrated on the lower side of FIG. 2, and hence no lookahead is done.

At a time T11, an access request is generated from the master 1 again. Since, however, the synchronous signal (burstd) generated from the signal (burst) indicative of the transfer type in this case is taken as “FIXED”, the “prefetch” signal generator 15c sets the prefetch signal to “prefetch”=1 in accordance with the logic shown in the same figure and instructs the memory control unit 15a to perform lookahead control. Thus, data at an address A+6 is read ahead in succession to addresses A+4 and A+5.

### Second Preferred Embodiment

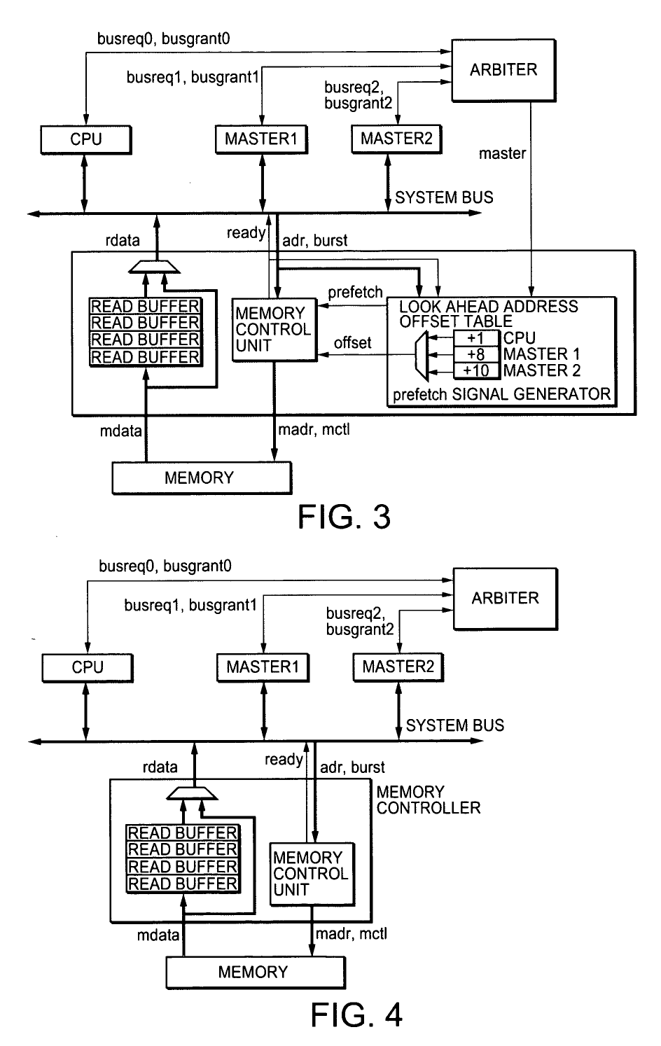

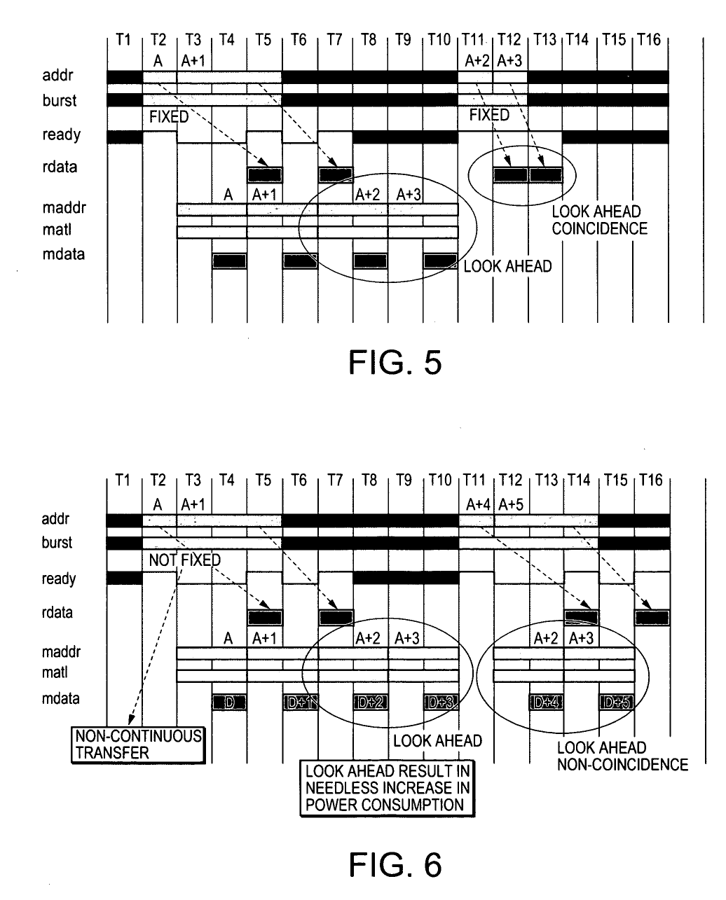

A lookahead control method according to a second embodiment is of a method for discriminating accesses made from a plurality of masters under lookahead control of a read buffer in a memory controller accessed from the plural masters to thereby enhance lookahead accuracy in accordance with the characteristics of operations done every masters, even where the next address is noncontiguous. FIG. 3 is a configuration view of a system according to the second embodiment.

In a manner similar to the system according to the first embodiment, the system according to the present embodiment includes a system bus 31, a CPU (32), a master 1 (33) and a master 2 (34) used as masters that offer access requests, and an arbiter 36 which arbitrates among bus access requests, and a memory controller 35 which controls between an external memory 37 and the system bus 31. In a manner similar to the first embodiment, the memory controller 35 is equipped with a memory control unit 35a, a read buffer 35a, and a “prefetch” signal generator 35c.

The present embodiment is different in system configuration from the first embodiment in that the “prefetch” signal generator 35c is provided with a lookahead address offset table 38 in which rules for lookahead addresses set every masters have been described. When the master that offers an access request, for example, is taken as the CPU (32), +1 is set to a location for the CPU in the table if a value obtained by adding +1 to the present address is suitable as a lookahead address. In the case of an access request made from the master 1, +8 is set to a location for the master 1 in the table if a value obtained by adding +8 to the present address is suitable as a lookahead address. Similarly even in the case of the master 2, suitable values are set to their corresponding addresses in the table.

When the memory control unit 35a performs lookahead in response to a “prefetch” signal, it adds the value of an offset given from the lookahead address offset table 38 to the present address to generate a lookahead address. Operating timings are similar to those employed in the first embodiment.

While the preferred forms of the present invention have been described, it is to be understood that modifications will be apparent to those skilled in the art without departing from the spirit of the invention. The scope of the invention is to be determined solely by the following claims.

What is claimed is:

1. A method for controlling lookahead of memory data with respect to one bus master selected in a system to which a plurality of bus masters and a memory are connected, comprising the step of:
determining whether lookahead control is carried out, based on a signal for discriminating the selected bus master and a signal for discriminating the type of transfer.

2. A method for controlling lookahead of memory data with respect to one bus master selected in a system to which a plurality of bus masters and a memory are connected, comprising the step of:
when it is determined that lookahead control is performed, based on a signal for discriminating the selected bus master and a signal for discriminating the type of transfer, allowing a lookahead address for the lookahead control to be controlled based on the bus master discrimination signal.
